(19) United States
(12) Patent Application Publication
(10) Pub. No.: US 2006/0294345 A1
(43) Pub. Date: Dec. 28, 2006

(54) Methods and apparatus for implementing branching instructions within a processor

(75) Inventors: Sean M. Furuness, Naperville, IL (US); Lawrence D. Weizeorick, Lisle, IL (US); Thayl D. Zohner, Naperville, IL (US)

Correspondence Address: Dean D. Small;Armstrong Teasdale LLP, Suite 2600, One Metropolitan Square, St. Louis, MO, 63102, US

(73) Assignee: Tellabs Operations, Inc.

(21) Appl. No.: 11/159,531

(22) Filed: Jun. 23, 2005

(51) Int. Cl. G06F 9/44

(52) U.S. Cl. 712/234

(57) ABSTRACT

A processor is described that includes a plurality of registers configured as a status stack. The processor is configured to sequentially store results from status producing instruction executions in the status stack and implement a branching instruction based on at least one of the stored results.

### BACKGROUND OF THE INVENTION

This invention relates generally to processor architectures, and more specifically, to methods and apparatus for implementing branching instructions within processors.

Embedded processors are often configured with limited space for code and a limited time to accomplish the assigned processing tasks. As an example of such limitations, prior approaches regarding processors generally involve the incorporation of branch instructions following every comparison that is executed within a program. The incorporation of multiple branch instructions generally lead to additional program space (e.g., memory) requirements and more program code is involved in the execution of such instructions. The additional program code may also lead to increases in execution times, which can sometimes present problems in real time applications.

To illustrate further, the following pseudo-code represents a high level function:

If ((rl = 0 and r2 = 5) or r3 = 7) then

dosomething

End if

The following is the above high level function reduced to processor operational codes:

| | |
|---|---|
| cmp r3, #7; | compare register 3 to 7 |
| beq dosomething; | Branch to “do_something” if equal |
| cmp r1, #0; | Compare register 1 with 0 |
| bne continue; | Branch to “continue” if not equal |
| cmp r2, #5; | Compare register 2 with 5 |
| bne continue; | Branch to “continue” if not equal |
| dosomething: | ** Code to execute if compare is true ** |
| continue: | ** execution continues here in either |
| | case ** |

In this specific example, each operational code takes one clock cycle to execute. Also specific to this example, branch operational codes take three clock cycles to execute when the branch is taken, and one clock cycle when the branch is not taken. The number of clock cycles for particular instructions varies will each processor implementation. However, such timing differences in branching instruction execution is typical of pipelined processors because if a branch is to be taken, an instruction pipeline, or instruction queue must be emptied (sometimes referred to as being flushed) and refilled with the operational codes relating to the branch to be next executed by the processor.

### BRIEF DESCRIPTION OF THE INVENTION

In an exemplary embodiment, a processor comprising a plurality of registers configured as a status stack is provided. The processor is configured to sequentially store results from status producing instruction executions in said status stack and implement a branching instruction that operates based on at least one of the stored results.

In another exemplary embodiment, a method for implementing branching instructions within a processor is provided. The method comprises executing a plurality of operational codes, each of which provides a status result, sequentially storing the status results, and utilizing one or more of the status results to determine whether a branching operation is to be executed.

In still another exemplary embodiment, a logic circuit for incorporation within a processing unit is provided. The logic circuit comprises a comparator configured to output a status result from an instruction executed by the processing unit, a plurality of registers configured as a stack, and a branching circuit. The comparator is configured to provide the status result to a first of the registers within the stack. The branching circuit is configured to receive a status opcode relating to status results stored in the registers, and further configured to apply a logical combination, based on the status opcode, to a number of the status results.

### BRIEF DESCRIPTION OF THE DRAWINGS

FIG. 1 is a block diagram of a processor that includes an arithmetic logic unit configured to store results of instruction executions.

FIG. 2 is a block diagram of an arithmetic logic unit including a status stack according to an embodiment of the present invention.

FIG. 3 is a detail block diagram of a comparator, status stack, and branch logic within an arithmetic logic unit.

FIG. 4 is a flowchart illustrating a branching method that may be incorporated into the processor of FIG. 1.

FIG. 5 is a system block diagram illustrating a processor within a computer system.

### DETAILED DESCRIPTION OF THE INVENTION

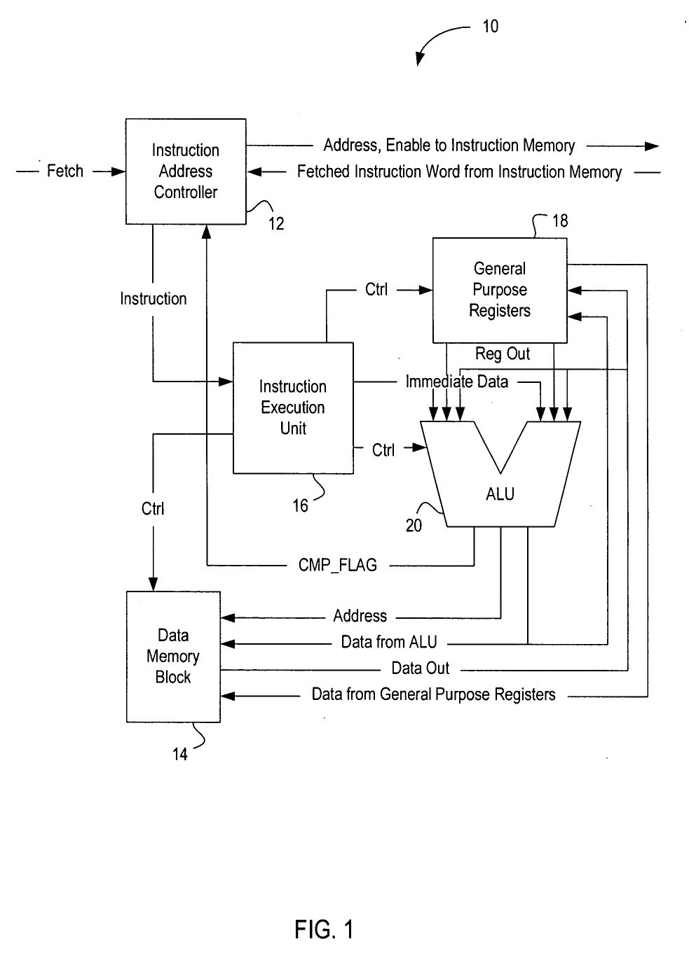

FIG. 1 is a functional block diagram of a processor 10 that is configured with a status stack (not shown in FIG. 1) therein to store results of a series of status producing instruction executions, for example, value comparisons. The status stack is also sometimes referred to as a hardware stack. Processor 10 is further configured to implement decision instructions that operate on the results stored in the status stack. An example of such decision instructions would be conditional branch type instructions. Implementation of the status stack, as further described below, results in a sequence of operational instructions that utilize less code space for storage of the instructions, and in a faster execution time than is associated with known processors.

Referring specifically to FIG. 1, processor 10 includes an instruction address controller 12, a data memory block 14, an instruction execution unit 16, general purpose registers 18 and an arithmetic logic unit (ALU) 20. As further described below, ALU 20 includes the status stack. The instruction address controller 12 fetches instructions from instruction memory (not shown). Fetched instructions and any data related to the instructions are then passed to the instruction execution unit 16 for execution. The instruction execution unit 16 and the ALU 20 perform the required operations (based on the fetched instructions) on data that is in general purpose registers 18, for example, data that has been retrieved from data memory block 14. The data memory block 14 may be further utilized to store results from the ALU 20.

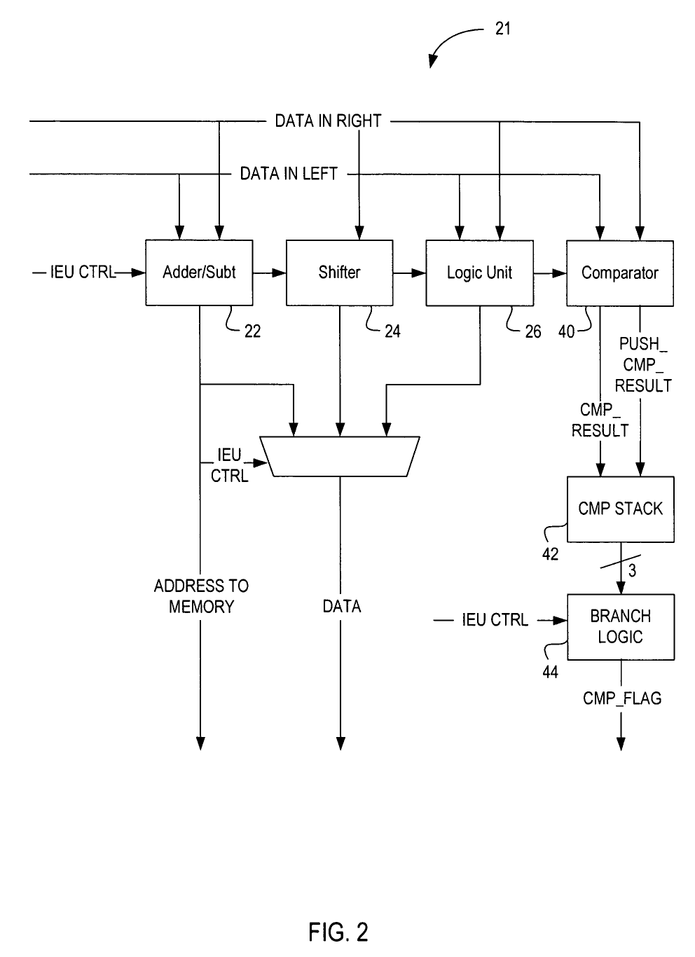

FIG. 2 is a block diagram of a portion of an arithmetic logic unit (ALU) 21 according to an embodiment of the present invention. ALU21 may be used to implement the ALU 20 (shown in FIG. 1). ALU 21 includes an adder/subtractor 22, a shifter 24, and a logic unit 26. ALU 21 performs logical and mathematical operations, for example, based on control signals received from an instruction execution unit, for example, the instruction execution unit 16 (shown in FIG. 1). ALU 21 further includes a comparator 40, status stack 42, and branch logic 44. Configuration of the ALU 21 with the status stack 42 provides the user with an ability to adjust operational codes for a processor, for example, the processor 10 (shown in FIG. 1). One result is the ability to perform the above described branching operation as follows:

| | |
|---|---|
| cmp r3, #7; | Compare register 3 to 7 |
| cmp r1, #0; | Compare register 1 with 0 |
| cmp r2, #5; | Compare register 2 with 5 |

| | |
|---|---|
| bne continue, 3; | Branch to “continue” if not equal |
| dosomething: | **code to execute if compare is true** |
| continue: | **execution continues here in either case** |

The result is that the processor incorporating ALU 21 is able to provide desired functional results while incorporating only one branch instruction that acts on the results (e.g., a logical combination) of the three comparisons. In other words, the branching instruction provides logical capabilities that allow the processor incorporating ALU 21 to execute a single branching instruction, without sequentially comparing, branching, comparing, branching, etc.

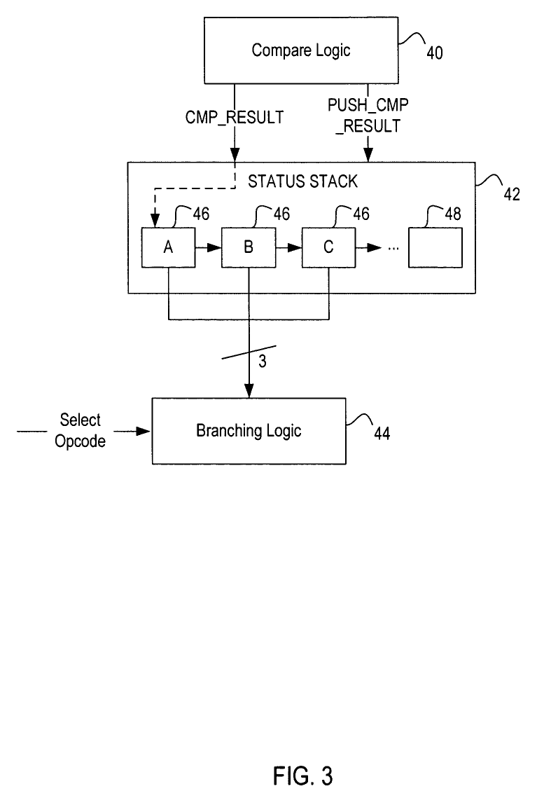

FIG. 3 is a detailed block diagram illustrating comparator 40, status stack 42, and branch logic 44. Comparator 40, status stack 42, and branch logic 44 may be incorporated within ALU 21 (shown in FIG. 2). When a compare (cmp) operational code is decoded by instruction execution unit 16, the comparator 40 (compare logic) is configured to perform the comparison operation and then “push” the result of the compare (cmp_result) onto the status stack 42. In one embodiment, if the comparison result is a positive result, a logical 0 is pushed onto the status stack 42 and if the comparison result is negative, a logical 1 is pushed onto the status stack 42.

In order to push the result of the compare onto the stack, the comparator 40 is configured to activate a push the comparison result (push_cmp_result) signal, which enables the latest compare result to be shifted onto the first register of the status stack 42. The status stack 42 is constructed from a plurality of serial shift registers 46 in one embodiment, and referring to the specific embodiment of FIG. 3, the status stack 42 is configured with three shift registers 46 labeled A, B, and C. As each comparison result is “pushed” onto the status stack 42 (and into register A), previously pushed results are shifted. For example the result previously in register A is shifted to register B, and the result previously in register B is shifted to register C and so on until the oldest result are shifted out of the last register of the stack. Another shift register 48, labeled n, is included to further illustrate that the status stack 42 may be configured with any number of shift registers 46.

The branch logic 44 logically combines a number of comparison results stored within the shift registers 46 of status stack 42 to determine whether a branch operation is to be performed. In the example of FIG. 3, the branch logic 44 is configured to receive the results of the latest three comparisons which allows for a number of possible logic combinations as further described below. Optionally, any number of comparisons can be made available to branch logic 44 based on the number of results stored in status stack 42. The three comparisons illustrated are to be considered as one example only. In order to determine which logical combination is to be applied to the stored results in status stack 42, the branch logic 44 is configured to receive a select opcode which defines the logical combination to be applied to the stored results.

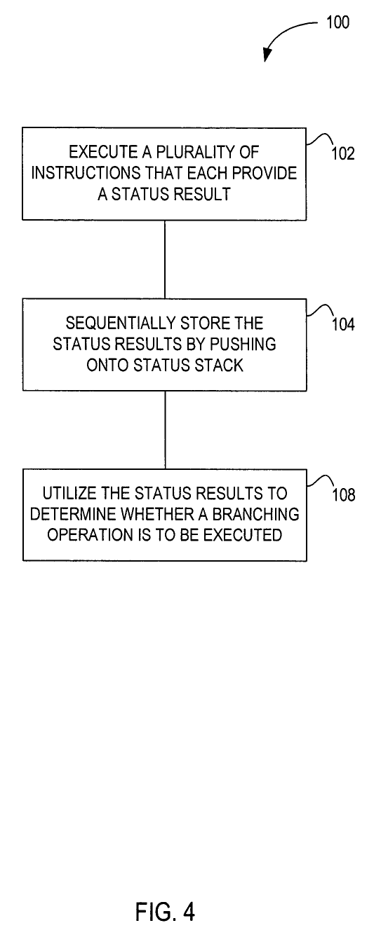

FIG. 4 is a flowchart 100 illustrating an instruction method that may be incorporated into the processor 10. The processor 10 is configured such that a method is provided for reducing a number of branching instructions to be executed by a processor. More particularly, the processor 10 is configured to execute 102 a plurality of operational codes, each of which provide a status result. The processor is also configured to sequentially store 104 the status results, for example, by pushing the results of executed code onto the status stack 42. The processor 10 is also configured to utilize 106 a plurality of the status results to determine whether a branching operation is to be executed.

To implement the above described method, certain features (comparator 40, status stack 42, and branch logic 44) may be implemented within the above described arithmetic logic unit 21. As described above, a status stack 42 is configured to sequentially store status of arithmetic operations. As such, whenever a new instruction executes that generates a status, its results are pushed onto a top of the status stack 42, and all previous results are pushed farther into the status stack 42. Typically however, the status stack 42 is a predetermined size and eventually results of such arithmetic and logical operations will be pushed off a bottom of the status stack 42. For example, consider the three compare operational instructions from the example above:

| | |
|---|---|
| cmp r3, #7; | Compare register 3 to 7 |
| cmp r1, #0; | Compare register 1 with 0 |
| cmp r2, #5; | Compare register 2 with 5 |

If it is assumed that the comparison operations (cmp) set a flag (one register of the status stack) to zero if the compared values are equal (a positive result) and one if the values are not equal (a negative result), and the results for the three compares are pushed onto the stack as follows:

| | |
|---|---|
| 0 | A |
| 0 | B |
| 1 | C |

The branching instruction illustrated above, “bne continue, 3;”, which generally means branch to the subroutine “continue” if the comparison results is not equal, also includes an instruction operand “3” that directly relates to the select opcode applied to the branch logic as defined above. The instruction operand in the code to be executed is logically applied as the select opcode to the branch logic and therefore instructs the processor 10 to select a predefined logical function to be applied to the stored results in the status stack 42 in order to make the branching decision. Referring again to the high level pseudo-code described above,

If ((rl = 0 and r2 = 5) or r3 = 7) then

dosomething

End if

An example of the possible combinations for the three comparisons within the pseudo-code, identified by the stack locations A, B, and C follows:

| INDEX | FUNCTION |
|---|---|
| 0 | A |
| 1 | A or B |
| 2 | A and B |
| 3 | (A and B) or C |
| 4 | A and (B or C) |
| 5 | A or B or C |
| 6 | A and B and C |

In the example, there are seven possible logical combinations of A, B, and C, so the instruction operand would have to be at least a three bit field. In the example, the high level operation desired is similar to the function defined by the index of “3”. As such the instruction operand of the branching instruction is “3” (thus a select opcode of 3 is input into branch logic 44) and indicates to the processor 10 to apply the (A and B) or C function to the last three stored status results on the status stack. As the “A” and “B” registers both represent equal comparisons, the branch will not occur and the “dosomething” subroutine will be run.

The example herein utilized to illustrate the branching function uses a three deep status stack and provides seven instruction operand choices. However, other implementations which utilize other status stack sizes, and therefore another number of instruction operand choices, are contemplated and are limited only by the particular hardware limitations of each processor.

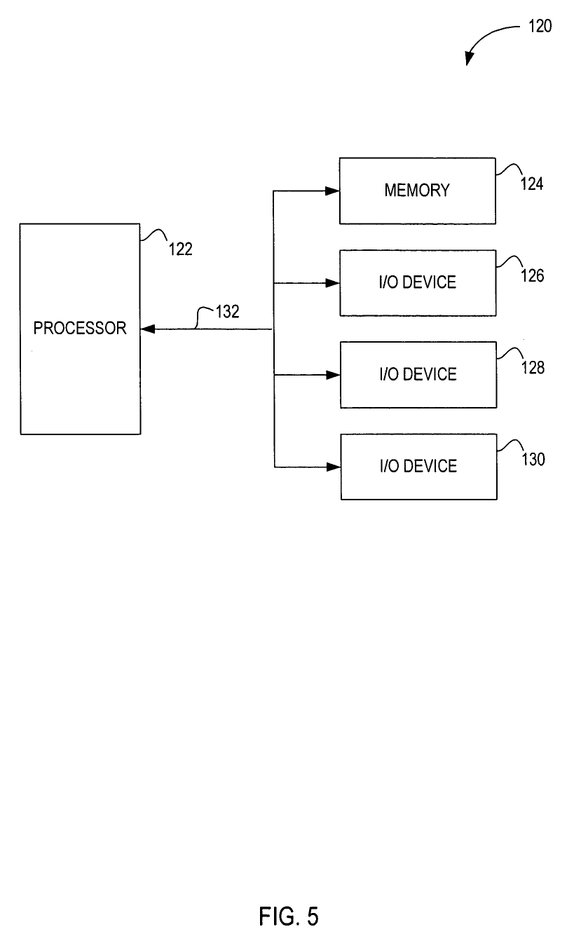

To further illustrate, FIG. 5 is a system block diagram that illustrates a processor operating within a computer system 120. The computer system 120 includes a processor 122, memory 124, and I/O devices 126, 128, and 130. A bus 132, provides communications (i.e., addressing and data) between the processor 122 and the memory 124, and between the processor 122 and the various I/O devices 126, 128, and 130. In one embodiment, the processor 122 incorporates the above described arithmetic logic unit (e.g., ALU 21) as well as comparator 40, status stack 42, and branch logic 44 to provide the above described benefits which respect to the execution of branching instructions.

Applications for a processor incorporating a status stack to reduce the number of branching operations include, but are not limited to, applications relating to telecom switching, routers, multiplexers, and demultiplexers. Such a processor is further applicable to the processing of frames of telecom data, real time, and network termination devices where latencies cannot exceed a predetermined amount.

While the invention has been described in terms of various specific embodiments, those skilled in the art will recognize that the invention can be practiced with modification within the spirit and scope of the claims.

What is claimed is:

1. A processor comprising a plurality of registers configured as a status stack, the processor configured to:
sequentially store results from status producing instruction executions in the status stack; and
implement a branching instruction based on at least one of the stored results.

2. A processor according to claim 1 wherein the processor comprises a comparator, the comparator configured to:
output a result for each status producing instruction executed; and
activate the status stack to initiate storage of the results.

3. A processor according to claim 1 comprising a branch logic circuit, the branch logic configured to:
logically combine at least a portion of the stored results; and
utilize a result of the combination to determine whether a branching instruction is to be executed.

4. A processor according to claim 1 comprising a branch logic circuit configured to:
receive the stored results from the status stack;
receive a select opcode, the select opcode defining a logical combination to be applied to the stored results; and
provide an output which characterizes a result of applying the logical combination to the stored results.

5. A processor according to claim 1 configured to execute a branching instruction only after at least one result has been pushed onto the status stack.

6. A processor according to claim 1 wherein to store results from a series of status producing instruction executions in the status stack, the processor is configured to push each result onto the status stack.

7. A method of implementing branching instructions within a processor, the method comprising:
executing a plurality of operational codes, each of which provides a status result;
sequentially storing the status results; and
utilizing one or more of the status results to determine whether a branching operation is to be executed.

8. A method according to claim 7 wherein executing a plurality of operational codes comprises executing a plurality of arithmetic operations.

9. A method according to claim 7 wherein sequentially storing the status results comprises pushing the status results onto a stack.

10. A method according to claim 7 wherein utilizing one or more of the status results comprises:
receiving a select opcode that define a logical combination to be applied to the stored status results; and
providing a signal that characterizes the logical combination as applied to the stored results.

11. A method according to claim 7 wherein sequentially storing the status results comprises:
outputting a result for each status producing instruction executed; and
activating a status stack to initiate storage of each result.

12. A method according to claim 7 wherein utilizing one or more of the status results comprises:
receiving a select opcode that define a logical combination to be applied to the stored status results; and
determining whether a branching instruction is to be executed based on the result of the logical combination.

13. A method according to claim 7 wherein sequentially storing the status results comprises pushing at least a first result onto the status stack before a branching instruction is to be executed.

14. A logic circuit for incorporation within a processing unit, said logic circuit comprising:
a comparator configured to output a status result from an instruction executed by the processing unit;
a plurality of registers configured as a stack, the comparator configured to provide the status result to a first of the registers within the stack; and
a branching circuit configured to receive a status opcode relating to status results stored in the registers, the branching circuit configured to apply a logical combination, based on the status opcode, to a number of the status results.

15. A logic circuit according to claim 14 wherein the comparator is configured to output an activating signal to the plurality of registers, the activating signal causing previously stored status results to shift to the next of the registers in the stack and further cause the latest status result to be stored in the first of the registers within the stack.

16. A logic circuit according to claim 14 wherein the plurality of registers comprises a plurality of shift registers.

17. A logic circuit according to claim 14 wherein the branch logic circuit is configured to:
receive the stored results from the status stack; and
provide an output which characterizes a result of applying the logical combination to the stored results.

18. A logic circuit according to claim 14 wherein the status stack comprises a plurality of serial shift registers.

19. A logic circuit according to claim 14 wherein the comparator is configured to push each individual status result onto the status stack.

20. A logic circuit according to claim 14 wherein the branching circuit is configured to determine if a branching operation should be performed by the processing unit based on a result of the logical combination.
